(19) United States
(12) Patent Application Publication
(10) Pub. No.: US 2026/0163695 A1
(43) Pub. Date: Jun. 11, 2026

(54) SYSTEM AND METHOD FOR WIRELESS COMMUNICATIONS UNDER MULTIPLE BSSID SUPPORT

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 19/410,917

(22) Filed: Dec. 5, 2025

Related U.S. Application Data
(60) Provisional application No. 63/728,207, filed on Dec. 5, 2024.

(51) Int. Cl. H04L 5/00; H04W 48/16

(52) U.S. Cl. CPC H04L 5/0048; H04W 48/16

(57) ABSTRACT

Embodiments of a method and apparatus for wireless communications are disclosed. In an embodiment, a wireless device includes a controller configured to generate a beacon frame of a transmitted Basic Service Set Identifier (BSSID) access point (AP) in a link supporting a multiple BSSID (MBSSID) feature, where the beacon frame includes an MBSSID element, which includes a nontransmitted BSSID profile of a nontransmitted BSSID AP in the link, and where the nontransmitted BSSID profile contains an Ultra High Reliability (UHR) BSS parameter change count (BPCC) of the nontransmitted BSSID AP, and a wireless transceiver configured to announce the beacon frame.

### CROSS-REFERENCE TO RELATED APPLICATIONS

This application is entitled to the benefit of U.S. Provisional Patent Application Ser. No. 63/728,207, filed on Dec. 5, 2024, the contents of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput.

### SUMMARY

Embodiments of a method and apparatus for wireless communications are disclosed. Embodiments of a method and apparatus for wireless communications are disclosed. In an embodiment, a wireless device includes a controller configured to generate a beacon frame of a transmitted Basic Service Set Identifier (BSSID) access point (AP) in a link supporting a multiple BSSID (MBSSID) feature, where the beacon frame includes an MBSSID element, which includes a nontransmitted BSSID profile of a nontransmitted BSSID AP in the link, and where the nontransmitted BSSID profile contains an Ultra High Reliability (UHR) BSS parameter change count (BPCC) of the nontransmitted BSSID AP, and a wireless transceiver configured to announce the beacon frame. Other embodiments are also disclosed.

In an embodiment, the nontransmitted BSSID profile further contains an UHR BPCC of a reported AP affiliated with same AP multi-link device (MLD) as the nontransmitted BSSID AP, and each time an UHR critical update related to the nontransmitted BSSID AP occurs or an UHR critical update related to the AP MLD that the nontransmitted BSSID AP is affiliated with occurs, the UHR BPCC of the nontransmitted BSSID AP is increased by 1.

In an embodiment, the UHR BPCC of the nontransmitted BSSID AP is carried in a common information (Info) field of a basic multi-link element.

In an embodiment, the critical UHR update related to the nontransmitted BSSID AP or the UHR critical update related to the AP MLD that the nontransmitted BSSID AP is affiliated with is carried in a plurality of beacons of the transmitted BSSID AP if the BPCC of the nontransmitted BSSID AP is increased by 1.

In an embodiment, the critical UHR update related to the nontransmitted BSSID AP or the UHR critical update related to the AP MLD that the nontransmitted BSSID AP is affiliated with is carried in the nontransmitted BSSID profile.

In an embodiment, the beacon frame includes an UHR critical update flag and a full critical update being carried flag of the nontransmitted BSSID AP.

In an embodiment, each time an UHR critical update related to the reported AP that is affiliated with the same AP MLD as the nontransmitted BSSID AP occurs or an UHR critical update related to the AP MLD that the reported AP is affiliated with occurs, the UHR BPCC of the reported AP is increased by 1.

In an embodiment, the UHR BPCC of the reported AP is carried in a Per station (STA) profile of a basic multi-link element.

In an embodiment, the UHR critical update related to the reported AP or the UHR critical update related to the AP MLD that the reported AP is affiliated with is carried in beacons of the transmitted BSSID AP if the UHR BPCC of the reported AP is increased by 1.

In an embodiment, the critical update related to the reported AP or the critical update related to the AP MLD that the reported AP is affiliated with is carried in a Per station (STA) profile of a basic multi-link element in the nontransmitted BSSID Profile of the nontransmitted BSSID AP.

In an embodiment, the wireless device is compatible with an Institute of Electrical and Electronics Engineers (IEEE) 802.11 protocol.

In an embodiment, a method for wireless communications includes at a wireless device, generating a beacon frame of a transmitted Basic Service Set Identifier (BSSID) access point (AP) in a link supporting a multiple BSSID (MBSSID) feature, where the beacon frame includes an MBSSID element, which includes a nontransmitted BSSID profile of a nontransmitted BSSID AP in the link, and where the nontransmitted BSSID profile contains an Ultra High Reliability (UHR) BSS parameter change count (BPCC) of the nontransmitted BSSID AP, and at the wireless device, announcing the beacon frame.

In an embodiment, the nontransmitted BSSID profile further contains an UHR BPCC of a reported AP affiliated with same AP multi-link device (MLD) as the nontransmitted BSSID AP, and each time an UHR critical update related to the nontransmitted BSSID AP occurs or an UHR critical update related to an the AP MLD that the nontransmitted BSSID AP is affiliated with occurs, the UHR BPCC of the nontransmitted BSSID AP is increased by 1.

In an embodiment, the UHR BPCC of the nontransmitted BSSID AP is carried in a common information (Info) field of a basic multi-link element.

In an embodiment, the critical UHR update related to the nontransmitted BSSID AP or the UHR critical update related to the AP MLD that the nontransmitted BSSID AP is affiliated with is carried in beacons of the transmitted BSSID AP if the BPCC of the nontransmitted BSSID AP is increased by 1.

In an embodiment, the critical UHR update related to the nontransmitted BSSID AP or the UHR critical update related to the AP MLD that the nontransmitted BSSID AP is affiliated with is carried in the nontransmitted BSSID profile.

In an embodiment, the beacon frame includes an UHR critical update flag and a full critical update being carried flag of the nontransmitted BSSID AP.

In an embodiment, each time an UHR critical update related to the reported AP that is affiliated with the same AP MLD as the nontransmitted BSSID AP occurs or an UHR critical update related to the AP MLD that the reported AP is affiliated with occurs, the UHR BPCC of the reported AP is increased by 1.

In an embodiment, the UHR BPCC of the reported AP is carried in a Per station (STA) profile of a basic multi-link element.

In an embodiment, the UHR critical update related to the reported AP or the UHR critical update related to the AP MLD that the reported AP is affiliated with is carried in beacons of the transmitted BSSID AP if the BPCC of the reported AP is increased by 1.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with example embodiments.

FIG. 3 depicts a wireless device in accordance with example embodiments.

FIG. 4 depicts AP MLDs with different communication links in accordance with example embodiments.

FIG. 5 depicts a configuration of a physical AP device with multiple AP MLDs owning the different communication links depicted in FIG. 4 in accordance with example embodiments.

FIG. 6 depicts a new defined element format carrying an UHR BPCC in accordance with example embodiments.

FIG. 7 depicts a beacon format that contains the new defined element format depicted in FIG. 6 in accordance with example embodiments.

FIG. 8 depicts a current defined element format carrying an UHR BPCC in accordance with example embodiments.

FIG. 9 depicts a multi-link control field in accordance with example embodiments.

FIG. 10 depicts a presence bitmap subfield in accordance with example embodiments.

FIG. 11 depicts a common information (info) field in accordance with example embodiments.

FIG. 12 depicts a beacon format in accordance with example embodiments.

FIG. 13 depicts a beacon or ML probe response format in accordance with example embodiments.

FIG. 14 is a process flow diagram of a method for wireless communications in accordance with example embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

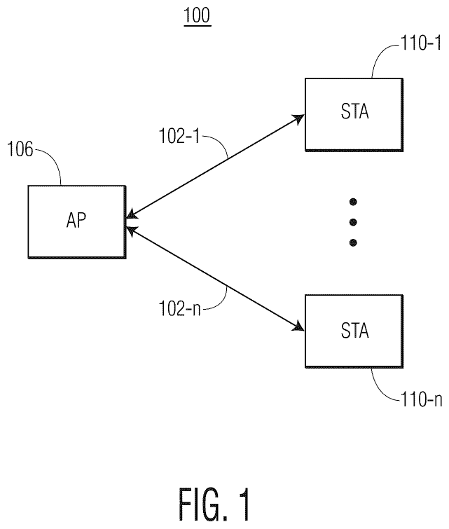

FIG. 1 depicts a wireless (e.g., WiFi) communications system 100 in accordance with example embodiments. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band. In some embodiments, the AP 106 is in the same multiple BSSID set as one or multiple APs where one AP, e.g., the AP 106, is the transmitted BSSID AP which the other APs are nontransmitted BSSID APs.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

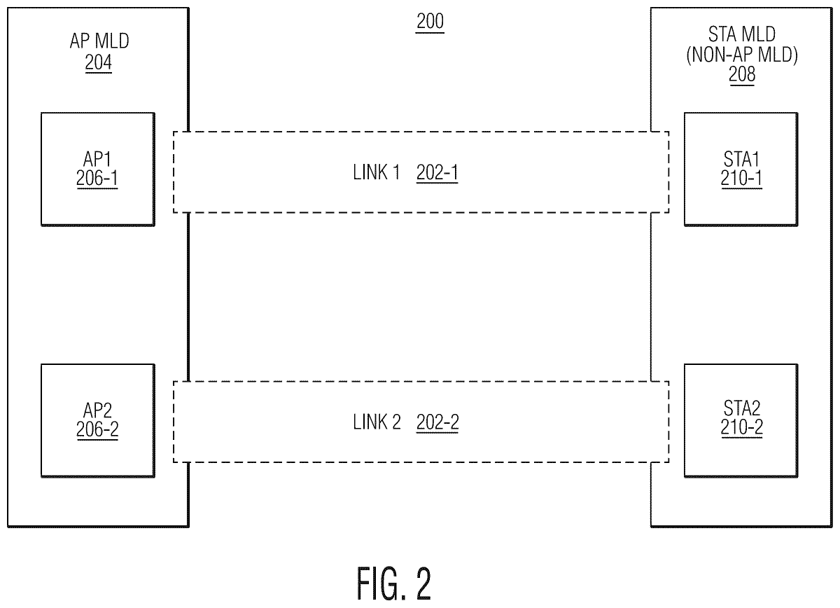

FIG. 2 depicts a multi-link (ML) communications system 200 that is used for wireless (e.g., WiFi) communications in accordance with example embodiments. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities that are common to multiple links (e.g., association establishment, reordering of frames, etc.) and a link specific part of the AP MLD 204, i.e., the APs 206-1 and 206-2, implement upper layer functionalities specific to a link and the lower layer MAC functionalities (e.g., Beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., data frames, beacon frames and the other management frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

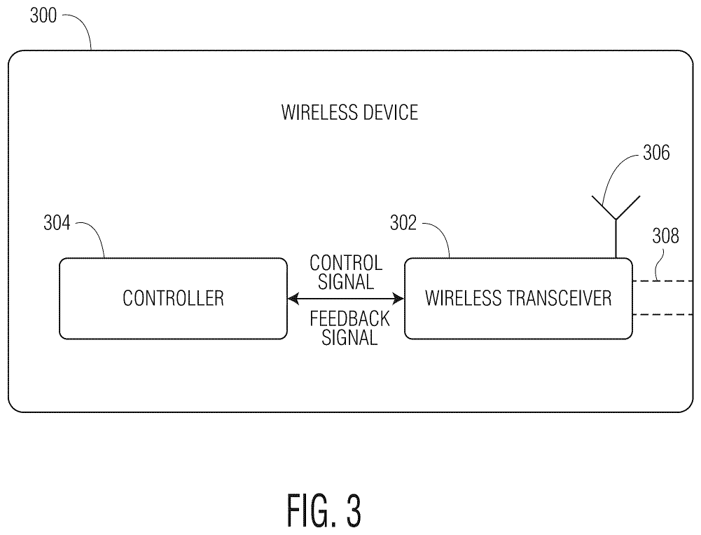

FIG. 3 depicts a wireless device 300 in accordance with example embodiments. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

To facilitate the proper data transmission within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

In accordance with an embodiment of the disclosure, the controller 304 is configured to generate a beacon frame of a transmitted Basic Service Set Identifier (BSSID) access point (AP) in a link supporting a multiple BSSID (MBSSID) feature, where the beacon frame includes a Multiple BSSID element, which includes a nontransmitted BSSID profile of a nontransmitted BSSID AP in the link, and where the nontransmitted BSSID profile contains an Ultra High Reliability (UHR) BSS parameter change count (BPCC) of the nontransmitted BSSID AP, and the wireless transceiver 302 is configured to announce the beacon frame, for example, through the at least one antenna 306. In some embodiments, an UHR BPCC of a device (e.g., the nontransmitted BSSID AP) provides a count to indicate changes in UHR Basic Service Set (BSS) parameters of the device (e.g., the nontransmitted BSSID AP). For example, the UHR BPCC allows a client or a wireless device to efficiently monitor when UHR BSS parameters have been updated by one or more affiliated access points (APs) (e.g., the nontransmitted BSSID AP) and/or one or more MLDs of the one or more affiliated APs, ensuring the client or the wireless device has the most current information for each link without needing to parse every change in detail or having to compare all parameters. In some embodiments, a change in the UHR BPCC of a device (e.g., the nontransmitted BSSID AP) indicates that at least one UHR parameter has changed in the device (e.g., the nontransmitted BSSID AP) and/or an MLD of the device, and a client or a wireless device can investigate further to find the specific changed UHR parameter. In some embodiments, a client or a wireless device can observing an UHR BPCC on one link while entering a low-power state on another link.

In a co-hosted AP set, each AP advertises its SSID (Service Set Identifier) in its own beacon frame, which consumed airtime and increased interference. With the multiple BSSID (MBSSID) feature, a single AP advertises several SSIDs within one beacon frame. For example, in an MBSSID set, only one AP is associated with a transmitted BSSID (Tx BSSID), which identifies the AP that transmits the Beacons, and one or more other APs may own one or more corresponding nontransmitted BSSIDs (non-Tx BSSIDs), which do not transmit their Beacons. A transmitted BSSID AP can include a multiple BSSID element in its beacon, advertising the information for one or more other virtual APs (the APs with nontransmitted BSSIDs in the same multiple BSSID set as the transmitted BSSID AP) in a single beacon frame. Nontransmitted BSSID APs within the same MBSSID set as the transmitted BSSID AP do not broadcast their own beacons. MBSSID significantly reduces management traffic on a wireless channel. For example, by consolidating beacon transmissions, MBSSID minimizes overhead and frees up airtime for actual data communication. MBSSID also lowers the risk of beacon collisions and interference, improving overall network efficiency, which is especially beneficial in environments where multiple virtual networks are needed, such as separating guest access from internal traffic or isolating IoT devices, resulting in a more scalable and responsive wireless infrastructure.

In some embodiments, the nontransmitted BSSID profile further contains an UHR BPCC of a reported AP affiliated with same AP multi-link device (MLD) as the nontransmitted BSSID AP, and each time an UHR critical update related to the nontransmitted BSSID AP occurs or an UHR critical update related to an AP MLD that the nontransmitted BSSID AP is affiliated with occurs, the UHR BPCC of the nontransmitted BSSID AP is increased by 1. In some embodiments, the UHR BPCC allows a client or a wireless device to efficiently monitor when UHR BSS parameters have been updated by one or more affiliated access points (APs) (e.g., the nontransmitted BSSID AP) and/or one or more MLDs of the one or more affiliated APs, ensuring the client or the wireless device has the most current information for each link without needing to parse every change in detail or having to compare all parameters. In some embodiments, a change in the UHR BPCC of a device (e.g., the nontransmitted BSSID AP) indicates that at least one UHR parameter has changed in the device (e.g., the nontransmitted BSSID AP) and/or an MLD of the device, and a client or a wireless device can investigate further to find the specific changed UHR parameter. In some embodiments, a client or a wireless device can observing an UHR BPCC on one link while entering a low-power state on another link. In some embodiments, the UHR BPCC of the nontransmitted BSSID AP is carried in a common information (Info) field of a basic multi-link element. In some embodiments, the critical UHR update related to the nontransmitted BSSID AP or the UHR critical update related to the AP MLD that the nontransmitted BSSID AP is affiliated with is carried in beacons of the transmitted BSSID AP if the BPCC of the nontransmitted BSSID AP is increased by 1. In some embodiments, the critical UHR update related to the nontransmitted BSSID AP or the UHR critical update related to the AP MLD that the nontransmitted BSSID AP is affiliated with is carried in the nontransmitted BSSID profile. In some embodiments, the beacon frame includes an UHR critical update flag and a full critical update being carried flag of the nontransmitted BSSID AP. In some embodiments, each time an UHR critical update related to the reported AP that is affiliated with the same AP MLD as the nontransmitted BSSID AP occurs or an UHR critical update related to the AP MLD that the reported AP is affiliated with occurs, the UHR BPCC of the reported AP is increased by 1. In some embodiments, the UHR BPCC of the reported AP is carried in a Per station (STA) profile of a basic multi-link element. In some embodiments, the UHR critical update related to the reported AP or the UHR critical update related to the AP MLD that the reported AP is affiliated with is carried in beacons of the transmitted BSSID AP if the UHR BPCC of the reported AP is increased by 1. In some embodiments, the critical update related to the reported AP or the critical update related to the AP MLD that the reported AP is affiliated with is carried in a Per station (STA) profile of a basic multi-link element in the nontransmitted BSSID Profile of the nontransmitted BSSID AP.

In some embodiments, the wireless device 300 includes the transmitted BSSID AP.

In some embodiments, the transmitted BSSID AP and the nontransmitted BSSID AP form an MBSSID set.

In some embodiments, the nontransmitted BSSID profile includes a basic multi-link element, which includes a common information (Info) field that carries the UHR BPCC of the nontransmitted BSSID AP.

In some embodiments, the nontransmitted BSSID profile includes a basic multi-link element, which includes a common information (Info) field that carries the UHR BPCC of the nontransmitted BSSID AP.

In some embodiments, the beacon frame includes an UHR critical update flag and a full critical update being carried flag of the nontransmitted BSSID AP.

In some embodiments, the nontransmitted BSSID profile further includes the UHR critical update flag and the full critical update being carried flag of the nontransmitted BSSID AP.

In some embodiments, the beacon frame includes a capability information and status indication field that carries the UHR critical update flag and the full critical update being carried flag of the nontransmitted BSSID AP.

In some embodiments, an UHR critical update is carried in the beacon frame if the UHR critical update flag is set to 1 and the full critical update being carried flag is set to 1.

In some embodiments, after waking up in the link, a non-AP multi-link device (MLD) checks the beacon frame before conducting frame exchanges in the link.

In some embodiments, the wireless device 300 is compatible with an Institute of Electrical and Electronics Engineers (IEEE) 802.11 protocol.

In some embodiments, the wireless device 300 is associated with a wireless multi-link device (MLD), and the wireless transceiver 302 is further configured to conduct frame exchanges with a second wireless MLD through wireless links between the wireless MLD and the second wireless MLD.

As described with examples, the relationship between the Critical Update Flag and the Ultra High Reliability (UHR) Critical Update Flag (e.g., a nontransmitted BSSID Critical Update Flag and an UHR nontransmitted BSSID Critical Update Flag related to a nontransmitted BSSID AP) is clarified. In addition, an UHR Basic Service Set (BSS) parameter change count (BPCC) is defined and the relationship between an UHR BPCC and a BPCC related to a nontransmitted BSSID AP is clarified. Further, an AP's behavior when critical update related UHR features occur or happen is clarified.

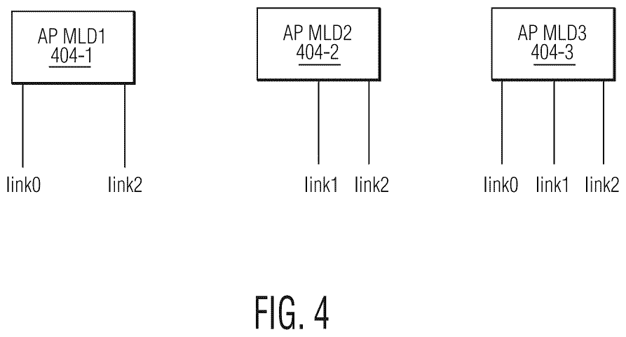

FIG. 4 depicts AP MLDs (AP MLD1 404-1), (AP MLD2 404-2), (AP MLD3 404-3) with different communication links link0, link1, link2 in accordance with example embodiments. In the embodiment depicted in FIG. 4, the AP MLD1 404-1 communicates via two communication links, e.g., link0 and link2, the AP MLD2 404-2 communicates via two communication links, e.g., link1 and link2, and the AP MLD3 404-3 communicates via three communication links, e.g., link0, link1, link2.

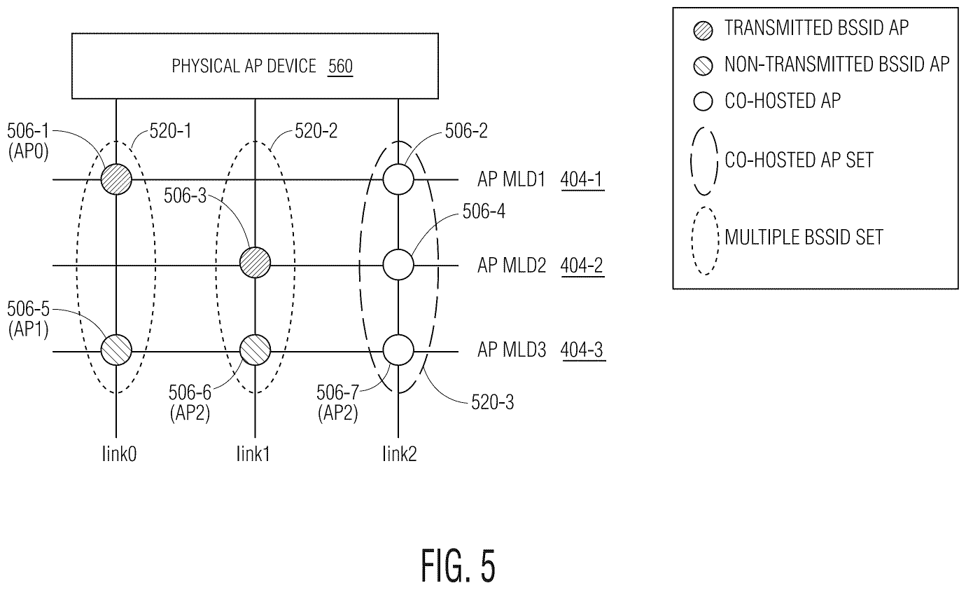

FIG. 5 depicts a configuration of a physical AP device 560 with multiple AP MLDs (the AP MLD1 404-1, the AP MLD2 404-2, the AP MLD3 404-3) owning the different communication links link0, link1, link2 depicted in FIG. 4 in accordance with example embodiments. As depicted in FIG. 5, the AP MLD1 404-1 includes two APs 506-1, 506-2, the AP MLD1 404-2 includes two APs 506-3, 506-4, and the AP MLD1 404-3 includes three APs 506-5, 506-6, 506-7. The AP 506-1 of the AP MLD1 404-1 and the AP 506-5 of the AP MLD3 404-3 are both in link0 and form a multiple BSSID set 520-1. In the multiple BSSID set 520-1, the AP 506-1 (also designated as AP0) of the AP MLD1 404-1 acts as a transmitted BSSID AP, while the AP 506-5 (also designated as AP1) of the AP MLD3 404-3 acts as a nontransmitted BSSID AP. The AP 506-3 of the AP MLD2 404-2 and the AP 506-6 of the AP MLD3 404-3 are both in link1 and form a multiple BSSID set 520-2. In the multiple BSSID set 520-2, the AP 506-3 of the AP MLD2 404-2 acts as a transmitted BSSID AP, while the AP 506-6 of the AP MLD3 404-3 acts as a nontransmitted BSSID AP. The AP 506-2 of the AP MLD1 404-1, the AP 506-4 of the AP MLD2 404-2, and the AP 506-7 of the AP MLD3 404-3 are in link2 and form a co-hosted AP set 520-3. In the co-hosted AP set 520-3, the AP 506-2 of the AP MLD1 404-1, the AP 506-4 of the AP MLD2 404-2, and the AP 506-7 of the AP MLD3 404-3 are all co-hosted APs. In some embodiments, in the AP MLD3 404-3, each AP in its link, e.g., the AP 506-5 (also designated as AP1), acts as a reporting AP while transmitting the information of the other APs in the other links affiliated with the same AP MLD as the reporting AP, e.g., the AP 506-6 and the AP 506-7 (also designated as AP2) acts as reported APs of the AP 506-5.

In a co-hosted AP set, each AP advertises its information (e.g., capabilities, operation information etc.) in its own beacon frame, which consumed airtime and increased interference. In a multiple BSSID (MBSSID) set, a single AP advertises its information (capabilities, operation information etc.) and the information (e.g., capabilities, operation information etc.) of the APs in the same AP device that share the same antenna connector within one beacon frame. In an MBSSID set, an AP is designated as the transmitted BSSID AP, which transmits the Beacons, while other AP(s) has/have nontransmitted BSSIDs and their information is carried in the same beacon frame of the transmitted BSSID AP. MBSSID significantly reduces management traffic on a wireless channel. For example, by consolidating beacon transmissions, MBSSID minimizes overhead and frees up airtime for actual data communication. MBSSID also lowers the risk of beacon collisions and interference, improving overall network efficiency, which is especially beneficial in environments where multiple virtual networks are needed, such as separating guest access from internal traffic or isolating IoT devices, resulting in a more scalable and responsive wireless infrastructure.

In some embodiments, the UHR BPCC, UHR Critical Update Flag and Full Critical Update Being Carried Flag of a transmitted BSSID AP and reported APs affiliated with the same AP MLD as the transmitted BSSID AP are the same as the UHR BPCC, UHR Critical Update Flag and Full Critical Update Being Carried Flag of the AP without multiple BSSID support.

Some implementations of UHR BPCC, UHR Critical Update Flag and Full Critical Update Being Carried Flag of a nontransmitted BSSID AP and reported APs affiliated with the same AP MLD as the nontransmitted BSSID AP are described below with examples.

Some implementations for UHR BPCC, for example, performed by the wireless communications system 100 depicted in FIG. 1, the AP/STA of the multi-link (ML) communications system 200 in a link depicted in FIG. 2, the wireless device 300 depicted in FIG. 3, the AP MLD1 404-1, the AP MLD2 404-2, and the AP MLD3 404-3 with depicted in FIGS. 4 and 5, and/or the APs 506-1, 506-2, 506-3, 506-4, 506-5, 506-6, 506-7 with depicted in FIG. 5 are described.

In some embodiments, an UHR BPCC is defined for an UHR critical event of a nontransmitted BSSID AP (e.g., AP1 (the AP 506-5 depicted in FIG. 5) as a reporting AP) or each AP affiliated with the same AP MLD as the nontransmitted BSSID AP. In some embodiments, when an UHR critical update of a nontransmitted BSSID AP occurs or happens, the UHR BPCC of the nontransmitted BSSID AP is increased by one. In some embodiments, when an UHR critical update of an AP MLD with which a nontransmitted BSSID AP is affiliated occurs or happens, the UHR BPCC of each AP affiliated with the same AP MLD as the nontransmitted BSSID AP is increased by one.

In some embodiments, each beacon of the transmitted BSSID AP (e.g., AP0 (the AP 506-1 depicted in FIG. 5)) carries a nontransmitted BSSID AP (e.g., AP1 (the AP 506-5 depicted in FIG. 5))'s UHR BPCC (BSS parameters change count) in a nontransmitted BSSID Profile subelement for the nontransmitted BSSID AP in a Multiple BSSID element.

In some embodiments, in Option 1, the nontransmitted BSSID AP (e.g., AP1 (the AP 506-5 depicted in FIG. 5))'s UHR BPCC is carried in a new defined element, e.g., in the Common Info field of the UHR Multi-Link element where the UHR Multi-Link element is in the nontransmitted BSSID AP (e.g., AP1 (the AP 506-5 depicted in FIG. 5))'s nontransmitted BSSID Profile subelement.

In some embodiments, in Option 2, the UHR BPCC is carried in a current defined element, e.g., in the Common Info field of the Basic Multi-Link element in the nontransmitted BSSID AP (e.g., AP1 (the AP 506-5 depicted in FIG. 5))'s nontransmitted BSSID Profile subelement.

Some examples of a reported AP (e.g., AP2 (the AP 506-6 or the AP 506-7 depicted in FIG. 5))'s UHR BPCC where the reported AP is affiliated with the same AP MLD as a reporting AP (e.g., AP1 (the AP 506-5 depicted in FIG. 5)) are described as follows.

In some embodiments, in Option 1, in a transmitted BSSID AP (e.g., AP0 (the AP 506-1 depicted in FIG. 5))'s Beacon, a reported AP (e.g., AP2 (the AP 506-6 or the AP 506-7 depicted in FIG. 5))'s UHR BPCC is not carried.

In some embodiments, in Option 2, in the transmitted BSSID AP (e.g., AP0 (the AP 506-1 depicted in FIG. 5))'s Beacon, a reported AP (e.g., AP2 (the AP 506-6 or the AP 506-7 depicted in FIG. 5))'s UHR BPCC is carried in the Nontransmitted BSSID Profile for the reporting AP (e.g., AP1 (the AP 506-5 depicted in FIG. 5).

In some embodiments, in Option 2.1, an UHR Multi-Link element is defined where the Common Info carries the UHR BPCC of the reporting AP, each Per Link Info, e.g. the STA Info of Per Link Info, carries the UHR BPCC of a reported AP.

In some embodiments, in Option 2.2, in a Basic Multi-Link element, the Per Link Info field carries the UHR BPCC of a reported AP.

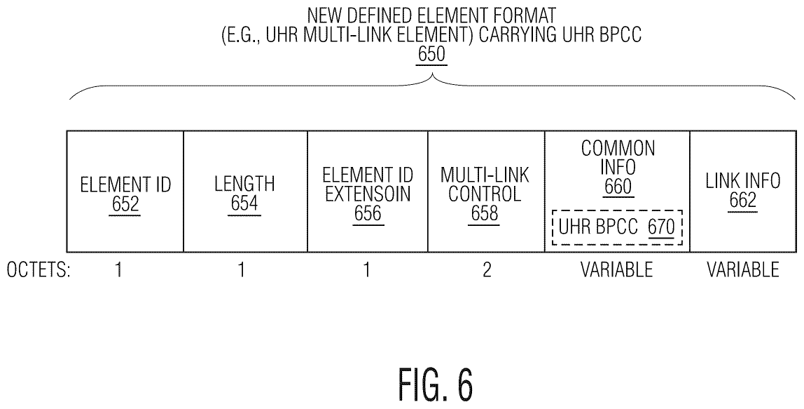

FIG. 6 depicts a new defined element format (e.g., an UHR Multi-Link element) 650 carrying an UHR BPCC 670 in accordance with example embodiments. In the embodiment depicted in FIG. 6, the new defined element format 650 includes an element identification (ID) field 652 (e.g., one-octet) that may contain identification information regarding which specific element this element represents, an element length field 654 (e.g., one-octet) that may contain element length information, an element ID extension field 656 (e.g., one-octet) that may contain ID extension information, a multi-link control field 658 (e.g., two-octet) that may contain multi-link control information, a common info field 660 (e.g., variable length) that may contain common information, and a link info field 662 (e.g., variable length) that may contain link information. In some embodiments, the common info field 660 contains the UHR BPCC 670.

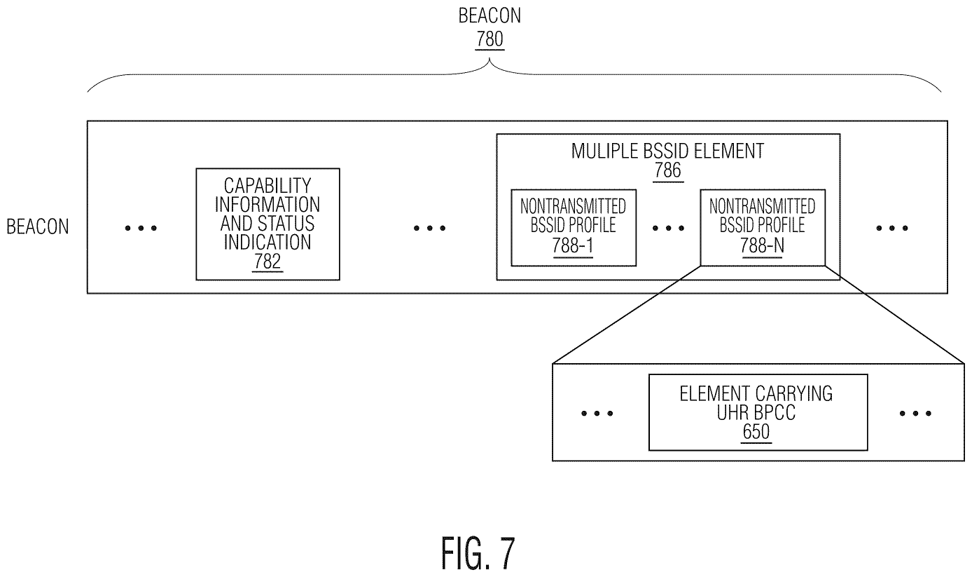

FIG. 7 depicts a beacon format 780 that contains the new defined element format 650 depicted in FIG. 6 in accordance with example embodiments. In the embodiment depicted in FIG. 7, the beacon format 780 includes capability information and status indication 782 and a multiple BSSID element 786, which includes one or more nontransmitted BSSID Profile 788-1, . . . , 788-n, where n is a positive integer. As depicted in FIG. 7, the nontransmitted BSSID Profile 788-n contains the new defined element format 650.

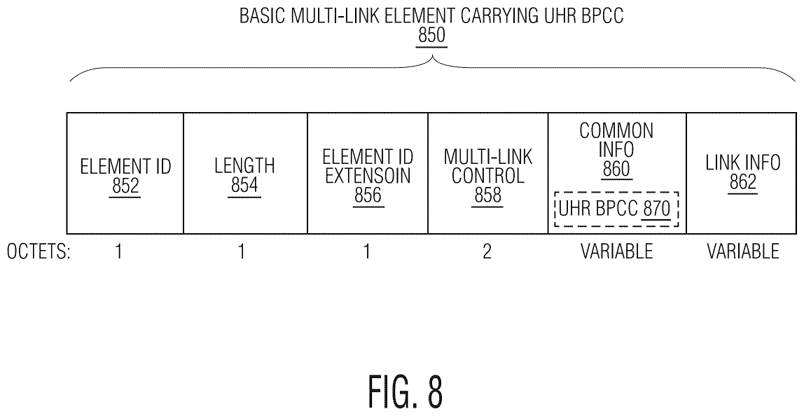

FIG. 8 depicts a current defined element format (e.g., a Basic Multi-Link element) 850 carrying an UHR BPCC 870 in accordance with example embodiments. In the embodiment depicted in FIG. 8, the current defined element format 850 includes an element identification (ID) field 852 (e.g., one-octet) that may contain identification information regarding which specific element this element represents, an element length field 854 (e.g., one-octet) that may contain element length information, an element ID extension field 856 (e.g., one-octet) that may contain ID extension information, a multi-link control field 858 (e.g., two-octet) that may contain multi-link control information, a common info field 860 (e.g., variable length) that may contain common information, and a link info field 862 (e.g., variable length) that may contain link information. In some embodiments, the common info field 860 contains the UHR BPCC 870 of the reporting AP. In some embodiments, the Per STA Profile in the link info field 862 contains the UHR BPCC of the reported AP.

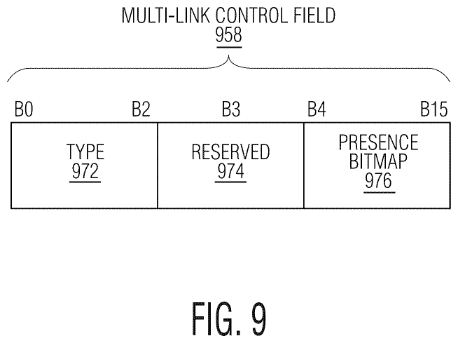

FIG. 9 depicts a multi-link control field 958 in accordance with example embodiments. The multi-link control field 958 depicted in FIG. 9 is one possible embodiment of the multi-link control field 858 depicted in FIG. 8. In the embodiment depicted in FIG. 9, the multi-link control field 958 includes a type subfield 972 (e.g., three-bit) that may contain type information, a reserved subfield 974 (e.g., three-bit) that may contain reserved information, and a presence bitmap subfield 976 (e.g., twelve-bit) that may contain presence bitmap information.

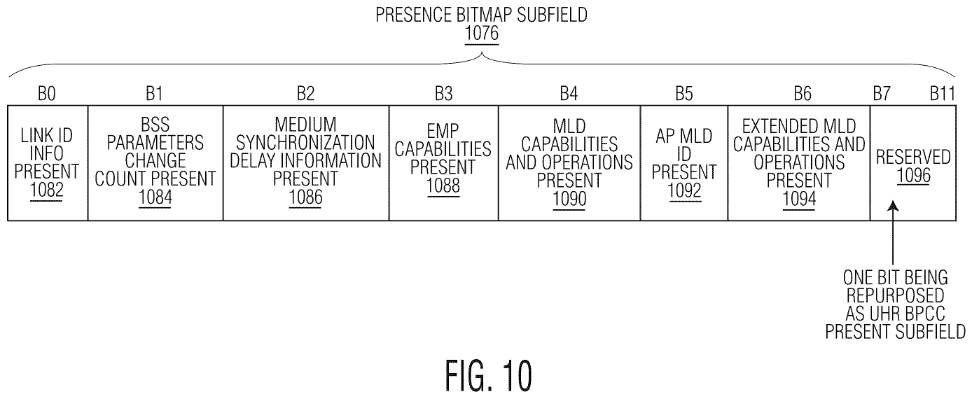

FIG. 10 depicts a presence bitmap subfield 1076 in accordance with example embodiments. The presence bitmap subfield 1076 depicted in FIG. 10 is one possible embodiment of the presence bitmap subfield 976 depicted in FIG. 9. In the embodiment depicted in FIG. 10, the presence bitmap subfield 1076 includes a link ID info present field 1082 (e.g., one-bit) that may contain link ID information present information, a BSS Parameters Change Count present field 1084 (e.g., one-bit) that may contain BSS Parameters Change Count present information, a Medium Synchronization Delay Information present field 1086 (e.g., one-bit) that may contain Medium Synchronization Delay Information present information, an Enhanced Multi-Link (EML) Capabilities Present field 1088 (e.g., one-bit) that may contain EML Capabilities Present information, an MLD Capabilities and Operations Present field 1090 (e.g., one-bit) that may contain MLD Capabilities and Operations Present information, an AP MLD ID Present field 1092 (e.g., one-bit) that may contain AP MLD ID Present information, an Extended MLD Capabilities and Operations Present 1094 (e.g., one-bit) that may contain Extended MLD Capabilities and Operations Present information, and a reserved field 1096 (e.g., five-bit) that may contain reserved information. In some embodiments, one bit of the reserved field 1096 is repurposed as an UHR BPCC Present subfield.

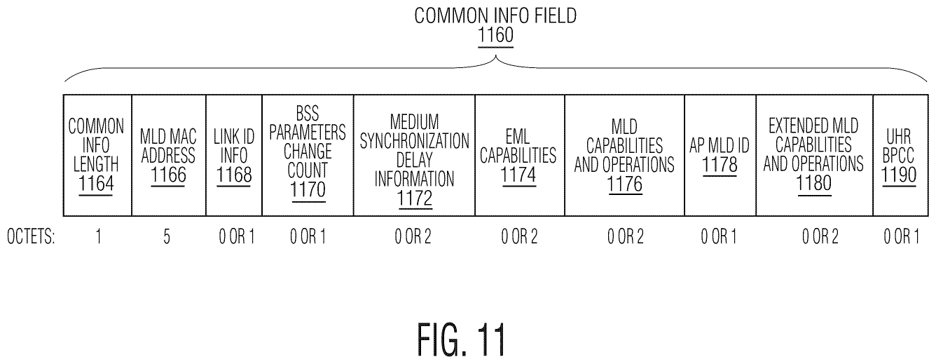

FIG. 11 depicts a common info field 1160 in accordance with example embodiments. The common info field 1160 depicted in FIG. 11 is one possible embodiment of the common info field 860 depicted in FIG. 8. In the embodiment depicted in FIG. 11, the common info field 1160 includes a common info length subfield 1164 (e.g., one-octet) that may contain common info length information, an MLD MAC address subfield 1166 (e.g., six-octet) that may contain MLD MAC address information, a link ID info subfield 1168 (e.g., zero or one octet) that may contain link ID information, a BSS parameters change count subfield 1170 (e.g., zero or one octet) that may contain BSS parameters change count information, a medium synchronization delay information subfield 1172 (e.g., zero or two octets) that may contain medium synchronization delay information, an EML capabilities subfield 1174 (e.g., zero or two octets) that may contain EML capabilities information, an MLD Capabilities and Operations field 1176 (e.g., zero or two octets) that may contain MLD Capabilities and Operations information, an AP MLD ID field 1178 (e.g., zero or one octet) that may contain AP MLD ID information, an Extended MLD Capabilities and Operations Present 1180 (e.g., zero or two octets) that may contain Extended MLD Capabilities and Operations information, and an UHR BPCC field 1190 (e.g., zero or one octet) that may contain UHR BPCC information. In some embodiments, if the UHR BPCC Present subfield has value 1, the UHR BPCC field 1190 is present and carries the UHR BPCC value.

Some implementations for UHR Critical Update Flag and Nontransmitted Basic Service Set Identifier (BSSID) UHR Critical Update Flag, for example, performed by the wireless communications system 100 depicted in FIG. 1, the AP/STA of the multi-link (ML) communications system 200 in a link depicted in FIG. 2, the wireless device 300 depicted in FIG. 3, the AP MLD1 404-1, the AP MLD2 404-2, and the AP MLD3 404-3 with depicted in FIGS. 4 and 5, and/or the APs 506-1, 506-2, 506-3, 506-4, 506-5, 506-6, 506-7 with depicted in FIG. 5 are described.

In some embodiments, the UHR Critical Update Flag in a Capability Information And Status Indication field of a nontransmitted BSSID Capability element, is used for nontransmitted BSSID AP.

In some embodiments, when a nontransmitted BSSID AP (e.g., AP1 (the AP 506-5 depicted in FIG. 5) has an UHR critical update, the UHR Critical Update Flag is set to 1 in a transmitted BSSID AP (e.g., AP0 (the AP 506-1 depicted in FIG. 5))'s several Beacons related to continuous Beacon intervals where at least one Beacon is the nontransmitted BSSID AP (e.g., AP1 (the AP 506-5 depicted in FIG. 5)'s DTIM (Delivery Traffic Indication Map) Beacon.

In some embodiments, when a reported AP (e.g., AP2 (the AP 506-6 or the AP 506-7 depicted in FIG. 5)) affiliated with the same AP MLD as a nontransmitted BSSID AP (e.g., AP1 (the AP 506-5 depicted in FIG. 5) has an UHR critical update, the UHR Critical Update Flag is set to 1 in a transmitted BSSID AP (e.g., AP0 (the AP 506-1 depicted in FIG. 5))'s several Beacons related to continuous Beacon intervals where at least one Beacon is AP1's DTIM Beacon. Another variant is that each AP's UHR Critical Update Flag is set independently from the other APs'UHR Critical Update Flag.

In some embodiments, when a reported AP (e.g., AP2 (the AP 506-6 or the AP 506-7 depicted in FIG. 5)) has critical update, a transmitted BSSID AP (e.g., AP0 (the AP 506-1 depicted in FIG. 5))'s Beacon doesn't carry the reported AP (e.g., AP2 (the AP 506-6 or the AP 506-7 depicted in FIG. 5))'s UHR Critical Update Flag with value 1.

In some embodiments, a new defined nontransmitted BSSID UHR Critical Update Flag, e.g., the repurposed reserved bit in Capability Information And Status Indication field, is defined.

In some embodiments, if/when the UHR Critical Update Flag of at least one nontransmitted BSSID AP has value 1, the nontransmitted BSSID UHR Critical Update Flag is set to 1.

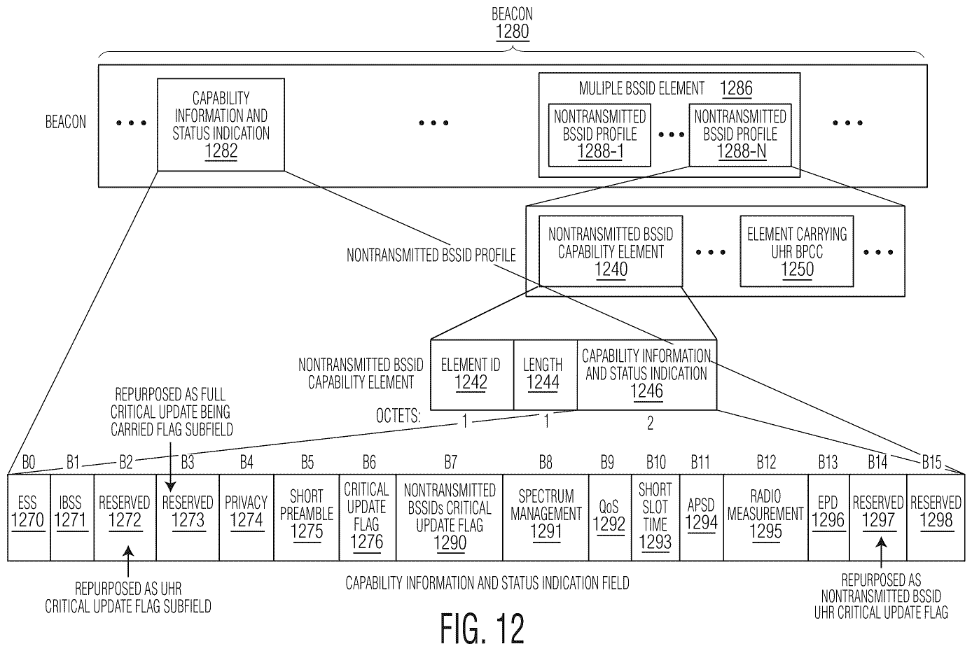

FIG. 12 depicts a beacon format 1280 in accordance with example embodiments. In the embodiment depicted in FIG. 12, the beacon format 1280 includes capability information and status indication 1282 and a multiple BSSID element 1286, which includes one or more nontransmitted BSSID Profile 1288-1, . . . , 1288-n, where n is a positive integer. In some embodiments, the nontransmitted BSSID Profile 1288-n contains a nontransmitted BSSID Capability element 1240 and an element carrying an UHR BPCC 1250. In some embodiments, the nontransmitted BSSID Capability element 1240 includes an element identification (ID) field 1242 (e.g., one-octet) that may contain identification information regarding which specific element this element represents, an element length field 1244 (e.g., one-octet) that may contain element length information, and a Capability Information and Status Indication field 1246 (e.g., two-octet) that may contain Capability Information and Status Indication information. In some embodiments, the Capability Information and Status Indication field 1246 includes an Extended Service Set (ESS) subfield 1270 (e.g., one-bit) that may contain ESS information, an Independent Basic Service Set (IBSS) subfield 1271 (e.g., one-bit) that may contain IBSS information, a reserved subfield 1272 (e.g., one-bit) that may contain reserved information, which can be repurposed as an UHR Critical Update Flag subfield, a reserved subfield 1273 (e.g., one-bit) that may contain reserved information, which can be repurposed as a Full Critical Update Being Carried Flag subfield, a privacy subfield 1274 (e.g., one-bit) that may contain privacy information, a short preamble subfield 1275 (e.g., one-bit) that may contain short preamble information, a critical update flag subfield 1276 (e.g., one-bit) that may contain critical update flag information, a nontransmitted BSSIDs critical update flag subfield 1290 (e.g., one-bit) that may contain nontransmitted BSSIDs critical update flag information, a spectrum management subfield 1291 (e.g., one-bit) that may contain spectrum management information, a quality of service (QoS) subfield 1292 (e.g., one-bit) that may contain QoS information, a short slot time subfield 1293 (e.g., one-bit) that may contain short slot time information, an Automatic Power Save Delivery (APSD) subfield 1294 (e.g., one-bit) that may contain APSD information, a radio management subfield 1295 (e.g., one-bit) that may contain radio management information, an EtherType protocol discrimination (EPD) subfield 1296 (e.g., one-bit) that may contain EPD information, a reserved subfield 1297 (e.g., one-bit) that may contain reserved information, which can be repurposed as a nontransmitted BSSID UHR Critical Update Flag subfield, and a reserved subfield 1298 (e.g., one-bit) that may contain reserved information.

Some implementations for Full Critical Update Being Carried Flag, for example, performed by the wireless communications system 100 depicted in FIG. 1, the AP/STA of the multi-link (ML) communications system 200 in a link depicted in FIG. 2, the wireless device 300 depicted in FIG. 3, the AP MLD1 404-1, the AP MLD2 404-2, and the AP MLD3 404-3 with depicted in FIGS. 4 and 5, and/or the APs 506-1, 506-2, 506-3, 506-4, 506-5, 506-6, 506-7 with depicted in FIG. 5 are described.

In some embodiments, the Full Critical Update Being Carried Flag in a Capability Information and Status Indication field of a nontransmitted BSSID Capability element is used for a nontransmitted BSSID AP. In some embodiments, when all the critical update(s) related to an UHR Critical Update Flag of the nontransmitted BSSID AP equal to 1 is carried in a Beacon, the Full Critical Update Being Carried Flag is set to 1.

Some implementations for Transmission of nontransmitted BSSID AP's UHR Critical Update, for example, performed by the wireless communications system 100 depicted in FIG. 1, the AP/STA of the multi-link (ML) communications system 200 in a link depicted in FIG. 2, the wireless device 300 depicted in FIG. 3, the AP MLD1 404-1, the AP MLD2 404-2, and the AP MLD3 404-3 with depicted in FIGS. 4 and 5, and/or the APs 506-1, 506-2, 506-3, 506-4, 506-5, 506-6, 506-7 with depicted in FIG. 5 are described.

Case 1 involves a nontransmitted BSSID AP's (as reporting AP's) critical update or AP MLD's UHR update.

In some embodiments, in Method 1, the UHR critical update related to a nontransmitted BSSID AP (e.g., AP1 (the AP 506-5 depicted in FIG. 5)) in the same multiple BSSID A set as a transmitted BSSID AP (e.g., AP0 (the AP 506-1 depicted in FIG. 5)) or an AP MLD with which the nontransmitted BSSID AP is affiliated is carried in the transmitted BSSID AP's Beacon if the nontransmitted BSSID AP's UHR Critical Update Flag is set to 1. In some embodiments, the nontransmitted BSSID AP (e.g., AP1 (the AP 506-5 depicted in FIG. 5))'s Full Critical Update Being Carried Flag in such Beacons is set to 1. In some embodiments, the nontransmitted BSSID UHR Critical Update Flag in such Beacons is set to 1.

In some embodiments, in Method 2, the UHR critical update related to a nontransmitted BSSID AP (e.g., AP1 (the AP 506-5 depicted in FIG. 5)) or an AP MLD with which the nontransmitted BSSID AP is affiliated is not carried in a transmitted BSSID AP (e.g., AP0 (the AP 506-1 depicted in FIG. 5))'s Beacon when the nontransmitted BSSID AP's UHR Critical Update Flag is set to 1. In some embodiments, the Full Critical Update Being Carried Flag in such Beacons is set to 0. In some embodiments, the nontransmitted BSSID UHR Critical Update Flag in such Beacons is set to 0 if there is no other nontransmitted BSSID AP's UHR critical update is carried in the transmitted BSSID AP (e.g., AP0 (the AP 506-1 depicted in FIG. 5))'s Beacon. In some embodiments, the transmitted BSSID AP (e.g., AP0 (the AP 506-1 depicted in FIG. 5) transmits a broadcast (ML) Probe Response without soliciting or per the soliciting by a Probe Request. In some embodiments, the UHR critical update related to the nontransmitted BSSID AP (e.g., AP1 (the AP 506-5 depicted in FIG. 5)) or the AP MLD is carried in Beacons. In some embodiments, the Full Critical Update Being Carried Flag in such Beacons is set to 1. In some embodiments, the broadcast Probe Response may be transmitted several times.

Case 2 involves the critical update of a reported AP (e.g., AP2 (the AP 506-6 or the AP 506-7 depicted in FIG. 5)) affiliated with the same AP MLD as a nontransmitted BSSID AP (e.g., AP1 (the AP 506-5 depicted in FIG. 5)) where AP0 is the transmitted BSSID AP in the same multiple BSSID AP set as AP1.

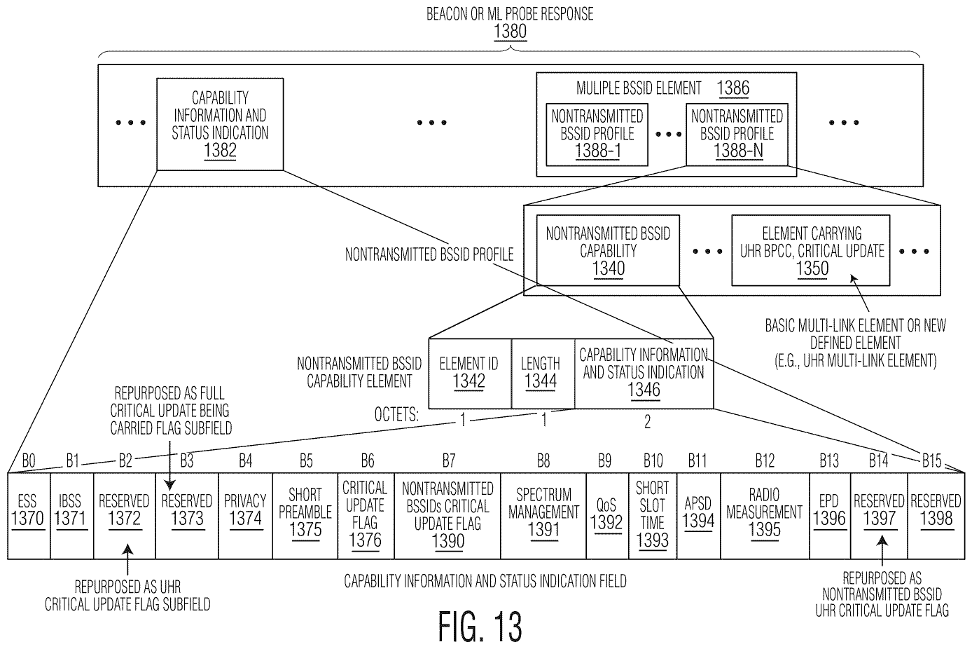

FIG. 13 depicts a beacon or ML probe response format 1380 in accordance with example embodiments. In the embodiment depicted in FIG. 13, the Beacon or ML Probe Response format 1380 includes capability information and status indication 1382 and a multiple BSSID element 1386, which includes one or more nontransmitted BSSID Profile 1388-1, . . . , 1388-n, where n is a positive integer. In some embodiments, the nontransmitted BSSID Profile 1388-n contains a nontransmitted BSSID Capability element 1340 and an element carrying an UHR BPCC or critical update 1350, which may be a Basic Multi-Link element or a new defined element (e.g., an UHR Multi-Link element). In some embodiments, the nontransmitted BSSID Capability element 1340 includes an element identification (ID) field 1342 (e.g., one-octet) that may contain identification information regarding which specific element this element represents, an element length field 1344 (e.g., one-octet) that may contain element length information, and a Capability Information and Status Indication field 1346 (e.g., two-octet) that may contain Capability Information and Status Indication information. In some embodiments, the Capability Information and Status Indication field 1346 includes an Extended Service Set (ESS) subfield 1370 (e.g., one-bit) that may contain ESS information, an Independent Basic Service Set (IBSS) subfield 1371 (e.g., one-bit) that may contain IBSS information, a reserved subfield 1372 (e.g., one-bit) that may contain reserved information, which can be repurposed as an UHR Critical Update Flag subfield, a reserved subfield 1373 (e.g., one-bit) that may contain reserved information, which can be repurposed as a Full Critical Update Being Carried Flag subfield, a privacy subfield 1374 (e.g., one-bit) that may contain privacy information, a short preamble subfield 1375 (e.g., one-bit) that may contain short preamble information, a critical update flag subfield 1376 (e.g., one-bit) that may contain critical update flag information, a nontransmitted BSSIDs critical update flag subfield 1390 (e.g., one-bit) that may contain nontransmitted BSSIDs critical update flag information, a spectrum management subfield 1391 (e.g., one-bit) that may contain spectrum management information, a quality of service (QoS) subfield 1392 (e.g., one-bit) that may contain QoS information, a short slot time subfield 1393 (e.g., one-bit) that may contain short slot time information, an Automatic Power Save Delivery (APSD) subfield 1394 (e.g., one-bit) that may contain APSD information, a radio management subfield 1395 (e.g., one-bit) that may contain radio management information, an EtherType protocol discrimination (EPD) subfield 1396 (e.g., one-bit) that may contain EPD information, a reserved subfield 1397 (e.g., one-bit) that may contain reserved information, which can be repurposed as a nontransmitted BSSID UHR Critical Update Flag subfield, and a reserved subfield 1398 (e.g., one-bit) that may contain reserved information.

In some embodiments, the UHR critical update related to the reported AP (e.g., AP2 (the AP 506-6 or the AP 506-7 depicted in FIG. 5)) is not carried in the transmitted BSSID AP (e.g., AP0 (the AP 506-1 depicted in FIG. 5)'s Beacon when the nontransmitted BSSID AP (e.g., AP1 (the AP 506-5 depicted in FIG. 5))'s UHR Critical Update Flag is set to 1. In some embodiments, the Full Critical Update Being Carried Flag of the nontransmitted BSSID AP (e.g., AP1 (the AP 506-5 depicted in FIG. 5)) in such Beacons is set to 0. In some embodiments, the transmitted BSSID AP (e.g., AP0 (the AP 506-1 depicted in FIG. 5) transmits a broadcast ML Probe Response without soliciting or per the soliciting by an ML Probe Request. In some embodiments, the UHR critical update related to the reported AP (e.g., AP2 (the AP 506-6 or the AP 506-7 depicted in FIG. 5)) is carried in an ML Probe Response. In some embodiments, the Full Critical Update Being Carried Flag of the nontransmitted BSSID AP (e.g., AP1 (the AP 506-5 depicted in FIG. 5)) in ML Probe Response is set to 1. The broadcast Probe Response may be transmitted several times. In some embodiments, the UHR critical update related to the reported AP (e.g., AP2 (the AP 506-6 or the AP 506-7 depicted in FIG. 5)) is carried in Beacons of AP0. In some embodiments, the critical update of the reported AP (e.g., AP2 (the AP 506-6 or the AP 506-7 depicted in FIG. 5)) is carried in the Per STA Profile of the reported AP in a Basic Multi-Link element of a nontransmitted BSSID Profile of a Multiple BSSID element of Beacons.

Some implementations for non-AP MLD's behavior, for example, performed by the wireless communications system 100 depicted in FIG. 1, the AP/STA of the multi-link (ML) communications system 200 in a link depicted in FIG. 2, the wireless device 300 depicted in FIG. 3, the AP MLD1 404-1, the AP MLD2 404-2, and the AP MLD3 404-3 with depicted in FIGS. 4 and 5, and/or the APs 506-1, 506-2, 506-3, 506-4, 506-5, 506-6, 506-7 with depicted in FIG. 5 are described.

In some embodiments, a non-AP MLD affiliated with an AP MLD whose affiliated APs include a nontransmitted BSSID AP (e.g., AP1 (the AP 506-5 depicted in FIG. 5)) records the UHR BPCC of the AP of the associated AP MLD in each setup link.

In some embodiments, if/when a STA of the non-AP MLD in link 1 receives transmitted BSSID AP0's Beacon with 1) Nontransmitted BSSID UHR Critical Update Flag and AP1's UHR Critical Update Flag being equal to 1, 2) AP1's UHR BPCC being larger than the UHR BPCC that the STA stored, and 3) AP1's Full Critical Update Being Carried Flag subfield equal to 1, then the STA acquires the UHR critical update in the Beacon and stores the AP1's UHR BPCC in the Beacon.

In some embodiments, if/when a STA of the non-AP MLD in link 1 receives AP0's Beacon with 1) Nontransmitted BSSID UHR Critical Update Flag and AP1's UHR Critical Update Flag being equal to 1, 2) AP1's UHR BPCC being same as the UHR BPCC that the STA stored, and 3) AP1's Full Critical Update Being Carried Flag subfield equal to 0, then the STA on behalf of the other STAs affiliated with the same non-AP MLD as the STA acquires the UHR critical update through receiving the ML Probe Response or transmitting a Probe Request to soliciting an ML Probe Response.

In some embodiments, if/when a STA of the non-AP MLD in link 1 receives AP0's Beacon with 1) Nontransmitted BSSID UHR Critical Update Flag and AP1's UHR Critical Update Flag being equal to 1, 2) AP1's UHR BPCC being larger than the UHR BPCC that the STA stored, and 3) AP1's Full Critical Update Being Carried Flag subfield equal to 0, then the STA acquires the UHR critical update of multiple APs that includes the reporting AP through receiving the ML Probe Response or transmitting a Probe Request to soliciting an ML Probe Response.

Some implementations for Extreme Low Power Non-AP MLD, for example, performed by the wireless communications system 100 depicted in FIG. 1, the AP/STA of the multi-link (ML) communications system 200 in a link depicted in FIG. 2, the wireless device 300 depicted in FIG. 3, the AP MLD1 404-1, the AP MLD2 404-2, and the AP MLD3 404-3 with depicted in FIGS. 4 and 5, and/or the APs 506-1, 506-2, 506-3, 506-4, 506-5, 506-6, 506-7 with depicted in FIG. 5 are described.

In some embodiments, when an extreme low power non-AP MLD wakes up in a link, the non-AP MLD needs to receive the Beacon in the link before executing the frame exchanges with the AP MLD in the link.

In some embodiments, if/when the UHR BPCC of the AP in the link is higher than the non-AP MLD's stored UHR BPCC in the link, the non-AP MLD acquires the critical update of the link through the probing procedure.

In some embodiments, a method of notifying its critical update by the first link device affiliated with the first device to the second link devices with each second link device affiliated with a second device involves announcing, by the first link device as a nontransmitted BSSID AP in a link supporting the multiple BSSID feature, the UHR BPCC, UHR Critical update flag, Full Critical Update Being Carried Flag of the nontransmitted BSSID AP in the Beacon of the transmitted BSSID AP, and recording, by the second device, its UHR BPCC of each link, and acquiring the new UHR critical update if a link's UHR BPCC announced by the first device through first link device is larger than its recorded UHR BPCC of the link. Full Critical Update Being Carried Flag. In some embodiments, if in a Beacon frame of a link, the Full Critical Update Being Carried Flag of nontransmitted BSSID AP is equal to 1 and UHR Critical update flag of nontransmitted BSSID AP is equal to 1, the transmitted BSSID AP's Beacon frame carries the UHR critical update indicated by the UHR BPCC. In some embodiments, if in a Beacon frame of a link, the Full Critical Update Being Carried Flag of nontransmitted BSSID AP is equal to 0 and UHR Critical update flag of nontransmitted BSSID AP is equal to 1, the transmitted BSSID AP's Beacon frame does not carry the UHR critical update indicated by the UHR BPCC. In some embodiments, the second link device solicits the UHR critical update if its recorded UHR BPCC is less than the Beacon's BPCC of associated nontransmitted BSSID AP, and no unsolicited ML Probe Response with the UHR critical update is received. In some embodiments, the UHR BPCC, UHR Critical update flag of nontransmitted BSSID AP are independent from BPCC and Critical Update flag of nontransmitted BSSID AP respectively. In some embodiments, the UHR Critical update flag, Full Critical Update Being Carried Flag of nontransmitted BSSID AP are carried in the Capability Information And Status Indication field. In some embodiments, after waking up in a link, an extreme low-power second device check UHR BPCC of the link and the UHR critical update if exists before doing the frame exchanges in the link.

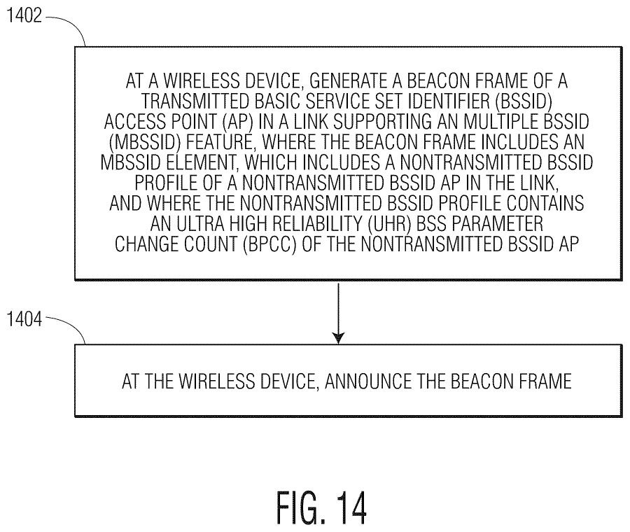

FIG. 14 is a process flow diagram of a method for wireless communications in accordance with example embodiments. At block 1402, at a wireless device, a beacon frame of a transmitted Basic Service Set Identifier (BSSID) access point (AP) in a link supporting a multiple BSSID (MBSSID) feature is generated, where the beacon frame includes an MBSSID element, which includes a nontransmitted BSSID profile of a nontransmitted BSSID AP in the link, and where the nontransmitted BSSID profile contains an Ultra High Reliability (UHR) BSS parameter change count (BPCC) of the nontransmitted BSSID AP. At block 1404, at the wireless device, the beacon frame is announced. In some embodiments, the wireless device is compatible with an Institute of Electrical and Electronics Engineers (IEEE) 802.11 protocol. In some embodiments, the nontransmitted BSSID profile further contains an UHR BPCC of a reported AP affiliated with same AP multi-link device (MLD) as the nontransmitted BSSID AP, and each time an UHR critical update related to the nontransmitted BSSID AP occurs or an UHR critical update related to an the AP MLD that the nontransmitted BSSID AP is affiliated with occurs, the UHR BPCC of the nontransmitted BSSID AP is increased by 1. In some embodiments, the UHR BPCC of the nontransmitted BSSID AP is carried in a common information (Info) field of a basic multi-link element. In some embodiments, the critical UHR update related to the nontransmitted BSSID AP or the UHR critical update related to the AP MLD that the nontransmitted BSSID AP is affiliated with is carried in beacons of the transmitted BSSID AP if the BPCC of the nontransmitted BSSID AP is increased by 1. In some embodiments, the critical UHR update related to the nontransmitted BSSID AP or the UHR critical update related to the AP MLD that the nontransmitted BSSID AP is affiliated with is carried in the nontransmitted BSSID profile. In some embodiments, the beacon frame includes an UHR critical update flag and a full critical update being carried flag of the nontransmitted BSSID AP. In some embodiments, each time an UHR critical update related to the reported AP that is affiliated with the same AP MLD as the nontransmitted BSSID AP occurs or an UHR critical update related to the AP MLD that the reported AP is affiliated with occurs, the UHR BPCC of the reported AP is increased by 1. In some embodiments, the UHR BPCC of the reported AP is carried in a Per station (STA) profile of a basic multi-link element. In some embodiments, the UHR critical update related to the reported AP or the UHR critical update related to the AP MLD that the reported AP is affiliated with is carried in beacons of the transmitted BSSID AP if the BPCC of the reported AP is increased by 1. The wireless device may be the same as or similar to an embodiment of the AP 106 and/or the STAs 110-1, . . . , 110-n depicted in FIG. 1, the APs 206-1, 206-2 and/or the STAs 210-1, 210-2 depicted in FIG. 2, and/or the wireless device 300 depicted in FIG. 3, an AP associated with the AP MLD1 404-1, the AP MLD2 404-2, and the AP MLD3 404-3 with depicted in FIGS. 4 and 5, and/or the APs 506-1, 506-2, 506-3, 506-4, 506-5, 506-6, 506-7 with depicted in FIG. 5.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the disclosure is to be defined by the claims appended hereto and their equivalents.

What is claimed is:

1. A wireless device comprising:
a controller configured to generate a beacon frame of a transmitted Basic Service Set Identifier (BSSID) access point (AP) in a link supporting a multiple BSSID (MBSSID) feature, wherein the beacon frame comprises an MBSSID element, which comprises a nontransmitted BSSID profile of a nontransmitted BSSID AP in the link, and wherein the nontransmitted BSSID profile contains an Ultra High Reliability (UHR) BSS parameter change count (BPCC) of the nontransmitted BSSID AP; and
a wireless transceiver configured to announce the beacon frame.

2. The wireless device of claim 1, wherein the nontransmitted BSSID profile further contains an UHR BPCC of a reported AP affiliated with same AP multi-link device (MLD) as the nontransmitted BSSID AP, and wherein each time an UHR critical update related to the nontransmitted BSSID AP occurs or an UHR critical update related to the AP MLD that the nontransmitted BSSID AP is affiliated with occurs, the UHR BPCC of the nontransmitted BSSID AP is increased by 1.

3. The wireless device of claim 2, wherein the UHR BPCC of the nontransmitted BSSID AP is carried in a common information (Info) field of a basic multi-link element.

4. The wireless device of claim 2, wherein the critical UHR update related to the nontransmitted BSSID AP or the UHR critical update related to the AP MLD that the nontransmitted BSSID AP is affiliated with is carried in a plurality of beacons of the transmitted BSSID AP if the BPCC of the nontransmitted BSSID AP is increased by 1.

5. The wireless device of claim 4, wherein the critical UHR update related to the nontransmitted BSSID AP or the UHR critical update related to the AP MLD that the nontransmitted BSSID AP is affiliated with is carried in the nontransmitted BSSID profile.

6. The wireless device of claim 4, wherein the beacon frame comprises an UHR critical update flag and a full critical update being carried flag of the nontransmitted BSSID AP.

7. The wireless device of claim 2, wherein each time an UHR critical update related to the reported AP that is affiliated with the same AP MLD as the nontransmitted BSSID AP occurs or an UHR critical update related to the AP MLD that the reported AP is affiliated with occurs, the UHR BPCC of the reported AP is increased by 1.

8. The wireless device of claim 7, wherein the UHR BPCC of the reported AP is carried in a Per station (STA) profile of a basic multi-link element.

9. The wireless device of claim 7, wherein the UHR critical update related to the reported AP or the UHR critical update related to the AP MLD that the reported AP is affiliated with is carried in a plurality of beacons of the transmitted BSSID AP if the UHR BPCC of the reported AP is increased by 1.

10. The wireless device of claim 9, wherein the critical update related to the reported AP or the critical update related to the AP MLD that the reported AP is affiliated with is carried in a Per station (STA) profile of a basic multi-link element in the nontransmitted BSSID Profile of the nontransmitted BSSID AP.

11. The wireless device of claim 1, wherein the wireless device is compatible with an Institute of Electrical and Electronics Engineers (IEEE) 802.11 protocol.

12. A method for wireless communications, the method comprising:
at a wireless device, generating a beacon frame of a transmitted Basic Service Set Identifier (BSSID) access point (AP) in a link supporting a multiple BSSID (MBSSID) feature, wherein the beacon frame comprises an MBSSID element, which comprises a nontransmitted BSSID profile of a nontransmitted BSSID AP in the link, and wherein the nontransmitted BSSID profile contains an Ultra High Reliability (UHR) BSS parameter change count (BPCC) of the nontransmitted BSSID AP; and
at the wireless device, announcing the beacon frame.

13. The method of claim 12, wherein the nontransmitted BSSID profile further contains an UHR BPCC of a reported AP affiliated with same AP multi-link device (MLD) as the nontransmitted BSSID AP, and wherein each time an UHR critical update related to the nontransmitted BSSID AP occurs or an UHR critical update related to an the AP MLD that the nontransmitted BSSID AP is affiliated with occurs, the UHR BPCC of the nontransmitted BSSID AP is increased by 1.

14. The method of claim 13, wherein the UHR BPCC of the nontransmitted BSSID AP is carried in a common information (Info) field of a basic multi-link element.

15. The method of claim 13, wherein the critical UHR update related to the nontransmitted BSSID AP or the UHR critical update related to the AP MLD that the nontransmitted BSSID AP is affiliated with is carried in a plurality of beacons of the transmitted BSSID AP if the BPCC of the nontransmitted BSSID AP is increased by 1.

16. The method of claim 15, wherein the critical UHR update related to the nontransmitted BSSID AP or the UHR critical update related to the AP MLD that the nontransmitted BSSID AP is affiliated with is carried in the nontransmitted BSSID profile.

17. The method of claim 15, wherein the beacon frame comprises an UHR critical update flag and a full critical update being carried flag of the nontransmitted BSSID AP.

18. The method of claim 13, wherein each time an UHR critical update related to the reported AP that is affiliated with the same AP MLD as the nontransmitted BSSID AP occurs or an UHR critical update related to the AP MLD that the reported AP is affiliated with occurs, the UHR BPCC of the reported AP is increased by 1.

19. The method of claim 18, wherein the UHR BPCC of the reported AP is carried in a Per station (STA) profile of a basic multi-link element.

20. The method of claim 18, wherein the UHR critical update related to the reported AP or the UHR critical update related to the AP MLD that the reported AP is affiliated with is carried in a plurality of beacons of the transmitted BSSID AP if the BPCC of the reported AP is increased by 1.
